(19) United States
(12) Patent Application Publication
(10) Pub. No.: US 2014/0372461 A1
(43) Pub. Date: Dec. 18, 2014

(54) NAMESPACE TRANSFORMATIONS

(71) Applicant: EL FRESKO TECHNOLOGIES LIMITED, Calgary (CA)

(72) Inventors: CHAD DAVID, Calgary (CA); JEFF RHYASON, Richmond (CA)

(21) Appl. No.: 14/308,173

(22) Filed: Jun. 18, 2014

(30) Foreign Application Priority Data
Jun. 18, 2013 (CA) 2820492

(51) Int. Cl. G06F 17/30

(52) U.S. Cl. CPC G06F 17/30569; G06F 17/30292
USPC 707/756

(57) ABSTRACT

A method of transforming source and union names, to allow namespace operations to be performed across any number of independent file systems, regardless of the object names present within those independent file system namespaces.

### BACKGROUND OF THE INVENTION

Computer file systems traditionally display and allow access to their contents via a hierarchy of names in a volume (the namespace) whose branches (directories) are structural, and whose leafs are files containing user data. Each of these directories or files make up an object in the namespace, and each object in a namespace directory must have a unique name. Namespace operations performed on a file system focus on unique object names. Objects that exist within the namespace are looked up by name, opened by name, unlinked by name, and read from or written to using state created by looking up an object by name.

A single directory may contain any number of other directories or files, but the name of each object must be unique within the scope of that directory. For instance, if the constraint of having unique names is not maintained, an ambiguity is created where the file system may not be able to determine what object is being requested. Within a single file system, the unique naming constraint can be maintained. The file system may check for naming conflicts at the time when an object is added into a namespace and reject names that would cause a conflict with an existing name. But, when independent file system namespaces are merged, so that all separate file systems appear and act as a single file system to create a unified file system, ambiguities may result due to conflicting names in the independent source namespaces. Thus, a solution is required to resolve naming conflicts that may result when one or more source namespaces are merged to create a union namespace.

A previously employed solution has been to give each source namespace a priority, and resolve conflicts (where an object had the same name as another object) by only exposing object names and allowing namespace operations on the objects from the source namespace with the highest priority, for any object that has a naming conflict.

This solution has the following disadvantages: a) only one of potentially many objects with the same name in a unified file system is visible at a time; b) when an object is removed (from the highest priority source namespace), an object with the same name from another source namespace may become visible, which may lead to confusion. For instance, a user may access the newly visible object, not realizing the old object was removed, or a user may remove the newly visible object, believing that the removal operation on the old object was unsuccessful. Some implementations that resolve conflicts in unified file systems, use whiteout entries that make lower priority objects with conflicting names unavailable even after a higher priority object with the same name is removed, but that only makes (a) more of a problem.

### BRIEF SUMMARY OF THE INVENTION

The present invention is a method that solves the issue of potential name conflicts, allowing namespace operations to be performed across one or more source namespaces by preventing naming conflicts, even where an object has the same name as another object, and allow unambiguous resolution of namespace operations. This is accomplished by transforming at least some of the source names to include some uniquely identifying information from their source namespace. The transformed source names may then function within a unified file system, similarly to a source namespace where all the names are unique.

Thus, unlike a typical union namespace, where source names are merged but the union namespace does not contain or make visible some of the names from source namespaces that conflict, all names from each source namespace may be visible without conflict, and may be accessed simultaneously, and independently.

The union name produced and presented may be produced at the request of an operating system level kernel and similarly, be presented to an operating system kernel interface.

### BRIEF DESCRIPTION OF THE SEVERAL VIEWS OF THE DRAWINGS

FIG. 1 shows the source names from two source namespaces being transformed and presented to form a union namespace.

FIG. 2 shows the reverse transformation of union names into source names within two source namespaces.

FIG. 3 shows the addition of names from a third source namespace to an existing union namespace.

FIG. 4 shows the removal of a group of union names, when all of the names from a source namespace are removed from the union namespace.

### DETAILED DESCRIPTION OF THE INVENTION

The present invention is a method of resolving name conflicts to allow namespace operations to be performed across one or more source namespaces. The method transforms source names by including some uniquely identifying information from their source namespace to avoid conflicts and ensure all names within the union namespace are unique. The method may transform names from any number of source namespaces, such that the transformed source names are unique and may be presented as union names in a union namespace for a unified file system, without any naming conflicts and allowing unambiguous access to each source name.

A requirement of this method is that each source namespace be assigned, or make available, a unique identifier (unique within the set of identifiers for the source namespaces that make up the union namespace). The format or content of the identifier is not critical; it may be human readable, computer readable, or both. The only constraint is that it be unique; however, specifying the unique identifier to include a user defined identifier (the name of the owner of the source namespace for example), or an industry acceptable method of generating an identifier (UUID or Microsoft GUID) is advantageous.

A namespace operation may be performed using the unified file system, without the requirement that the source name has been previously transformed into a union name. For instance, an object look up request to the unified file system may identify the underlying source object by taking the union name and transforming that name to unambiguously identify the object's source namespace and the source name, without the requirement that the source name had been previously transformed. In this manner, the unified file system may be considered a proxy to the underlying independent file system and the source objects within the source namespace.

Namespaces may be added to the union namespace, so long as the identifier assigned to the namespace to be added is unique within the set of identifiers for the source namespaces that make up the union namespace. Because the identifier for the namespace is unique within the union namespace, union names created using that identifier must also be unique within the union namespace. An added namespace to a union namespace becomes a source namespace to that union namespace, and the names of the added namespace are available for any namespace operation performed using the unified file system. Also, source namespaces may be removed from the union namespace. When a source namespace is removed from the union namespace, the removed source names from that namespace are no longer available for namespace operations performed using the unified file system, but no other source namespaces or source names are affected. Thus, adding or removing a source namespace to or from a union namespace will not result in any naming conflict or other ambiguity.

Furthermore, a source namespace may be changed by creating, renaming, or deleting a source namespace name, again without creating any naming conflict or other ambiguity. This is because when a source name is created or renamed, the source namespace file system will prevent any naming conflict within the source namespace, and the unique identifier for the source namespace ensures that all transformed source names (union names) are unique within the union namespace. Deleting or renaming a source name will not affect any other union name, because all union names are unique—there is no chance that deleting or renaming a source name will expose a different, previously unavailable, source name.

In the following description, naming examples and resulting formats are shown. It should be apparent, to one skilled in the art, that the present invention may be practiced without these specific formats.

Names within a namespace are unique in relation to other objects within the same namespace. For example, if a namespace already contains a name ‘file1’, any attempt to create another object with the same name will be rejected. This rejection avoids the possibility that a naming conflict will occur within a single file system, and the potential ambiguity that would result when a namespace operation is requested on an object that shares a name with another object. Within a single file system and a single namespace, the rejection is simple to enforce, but when merging a number of independent file systems and namespaces together, the constraint requiring the unique naming of objects becomes much more difficult to enforce.

By using source and union name transformations, namespace operations may be performed across any number of independent file systems as though all source names are unique. The source name transformation is applied to source names as they are retrieved from a source namespace. A union namespace name may also be transformed, such that given a union name, a source namespace and a source name can be determined.

f(S, n)=>(N); rf(N)=>{S, n}
f is a function which transforms source names into transformed names (union names).
S is added information that uniquely identifies a source name to its source namespace; S must be unique within the set of identifiers for the source namespaces that make up the union namespace.
Specifying the unique identifier to include a user or system defined identifier, or an industry acceptable method of generating an identifier (UUID or Microsoft GUID) is advantageous.
S may be the name or ID of the source namespace or some other unique identifier that is only present in this source namespace. S may be specified by the owner of the source namespace, may include a name of the owner of the source namespace, or specified by some other means so long as S is unique for each source namespace.
The owner of the source namespace may be the individual that creates the source namespace.
S may be defined at any point in time from when a source namespace is created up until the time when a source name is transformed.
n is a source namespace name.
N is a union namespace name.
The output off must be parseable by rf.
rf is a function which transforms union names into the added information that uniquely identifies the source namespace and the source name.

The role of function f is to transform source names from the source namespaces into unique names for a union namespace. For example, a source namespace identified as ‘NS1’, containing a file name ‘file1’, would be transformed by function f such that f(‘NS1’, ‘file1’) yields a transformed name ‘(NS1)-file1’ for the union namespace.

The role of function rf is to transform union names into source names and identify their source namespaces. For example, a union name ‘(NS1)-file1’, would be transformed by function rf such that rf(‘(NS1)-file1’) yields the source name ‘file1’ and identifies the source namespace as ‘NS1’. The rf function may be used to identify source namespaces and source names even when the f function has not transformed the source name previously, so long as the source namespace is joined to the union and the source name exists.

To create a union namespace requires only the following steps. At least one source namespace must be identified and unique identifiers must be specified for each source namespace identified. Once those steps are complete, namespace operations may be performed by using a unified file system accessing the union namespace. For example, if a user wanted to see all of the source names available within the union namespace, then that request to the unified file system would result in the transformation of each source name by function f and the presentation of the transformed names. Conversely, a user could instead perform a namespace operation on an underlying source name, without any prior transformation, if the user already knew the union name associated with that source name. By requesting the namespace operation on the union name, the unified file system would proxy that namespace operation to the file system with the underlying source name and source namespace identified by using the function rf.

Adding a namespace to a union namespace would require two steps. A unique identifier would need to be specified for that namespace, such that the identifier is not identical to the identifier used for any other source namespace in the union namespace. The namespace identifier must also be added to the set of identifiers for the source namespaces for the union namespace.

By ensuring that the unique identifier is in fact unique, when compared to the unique identifiers in the set of identifiers for the source namespaces in the union namespace, there is no potential for naming conflicts in the union namespace. This is because even if a source namespace to be added to the union namespace contains a source name that is the same as another source name within the union namespace, the unique identifiers for the source namespaces that contain the non-unique source names may never be the same, and thus the transformed source names will always be unique.

Removing a source namespace from a union namespace merely requires removing the identifier for the source namespace from the set of identifiers for the source namespaces in the union namespace. When a source namespace is removed from the set of source namespaces for the union namespace, the removed source names from that namespace are no longer available for namespace operations performed using the unified file system, but no other source namespaces or source names are affected.

Advantageously, transformations by the unified file system may be applied as namespace operations require those transformations. When a listing of union names is requested, the unified file system may request the source names from every source namespace to the union namespace, and apply the transformation to create union names from source names as the source names are retrieved from the source namespaces. When a namespace operation is requested on a union name, the transformation to identify the source name and source namespace may be applied to the union name and then the unified file system will proxy that namespace operation to the relevant file system with the source namespace and source name. Thus, the unified file system need not maintain the source names, source namespaces, and union names to perform namespace operations for the union namespace.

By presenting names transformed by function f in the union namespace, there is no possibility of any naming conflicts, and the sources of all names in the union namespace are unambiguously determinable. The union namespace may be presented in a single unified file system, containing all of the transformed source names. Function f may be used to transform a source name into a union name and function rf may be used to transform a union name into its source name as many times as needed. Function f will always yield a specific union name when applied to a specific source name; function rf will always yield a specific source name and specific source namespace from a specific union name.

Not all namespaces available to a unified file system need to be selected as source namespaces for a union namespace. Where there is a group of one or more namespaces available to a unified file system, a subset of these namespaces may be selected as the source namespace(s) for the union namespace. The unique identifier for a source namespace may be used to select and remove a namespace from the subset of namespaces selected as source namespaces.

In the following description, a possible embodiment of the invention is disclosed. It should be apparent, to one skilled in the art, that the present invention may be practiced without this specific embodiment.

Consider a number of independent file systems with associated independent namespaces that are to be joined into a unified file system, with a union namespace, such that unified file system namespace operations may be performed across the independent file systems and independent namespaces as though the independent namespaces were a single namespace to the unified file system.

Software creates a software instance that maintains a union namespace that is made up of the independent source namespaces. Each independent file system will have an associated independent namespace that is attached to the software instance. For each independent namespace to be included in a union namespace (and attached to the software instance), the independent namespace must have a unique identifier. The unique identifiers for independent namespaces, which will be source namespaces to the union namespace, must be provided to the software instance.

When a namespace operation is requested through the unified file system, the software instance where the request is made fulfills that request by using the set of unique identifiers and performing at least one name transformation by the function f or rf. The name transformation is then used to complete the unified file system namespace operation.

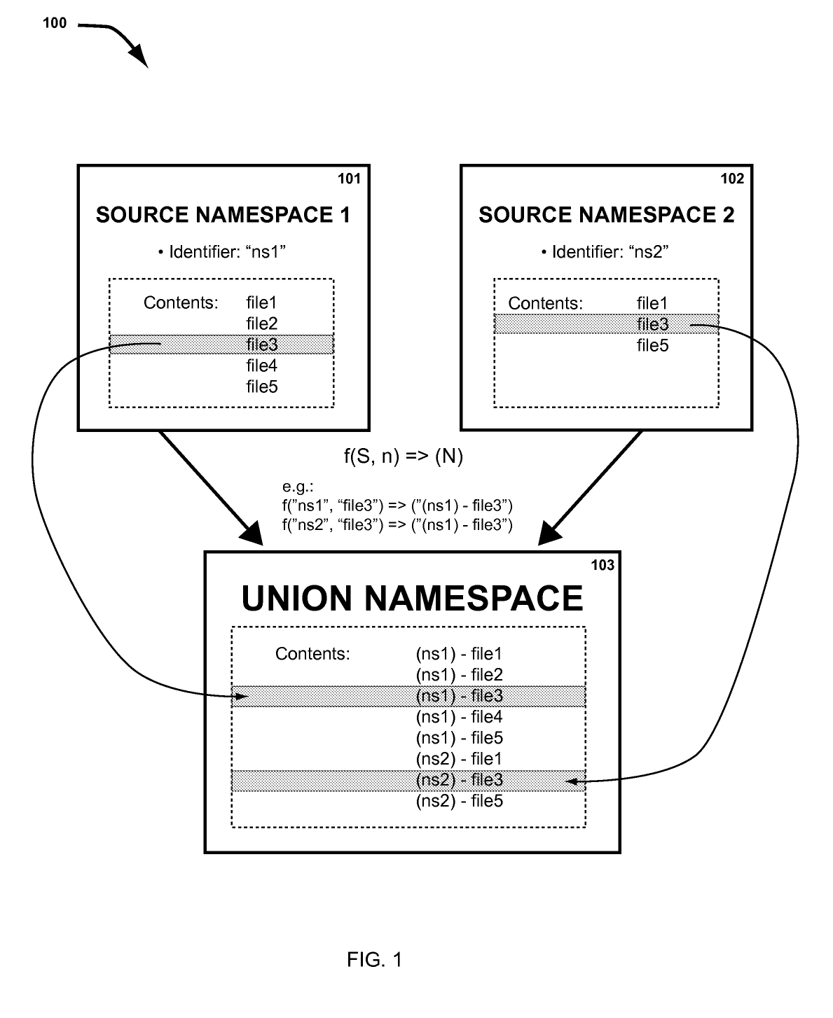

FIG. 1 shows the source names from two source namespaces being transformed and presented to form a union namespace. FIG. 1 demonstrates the mapping of names from source namespaces represented by blocks 101 and 102 to the union namespace represented by block 103. The uniqueness of names from the source namespaces are preserved, by passing them through function f, in the union namespace.

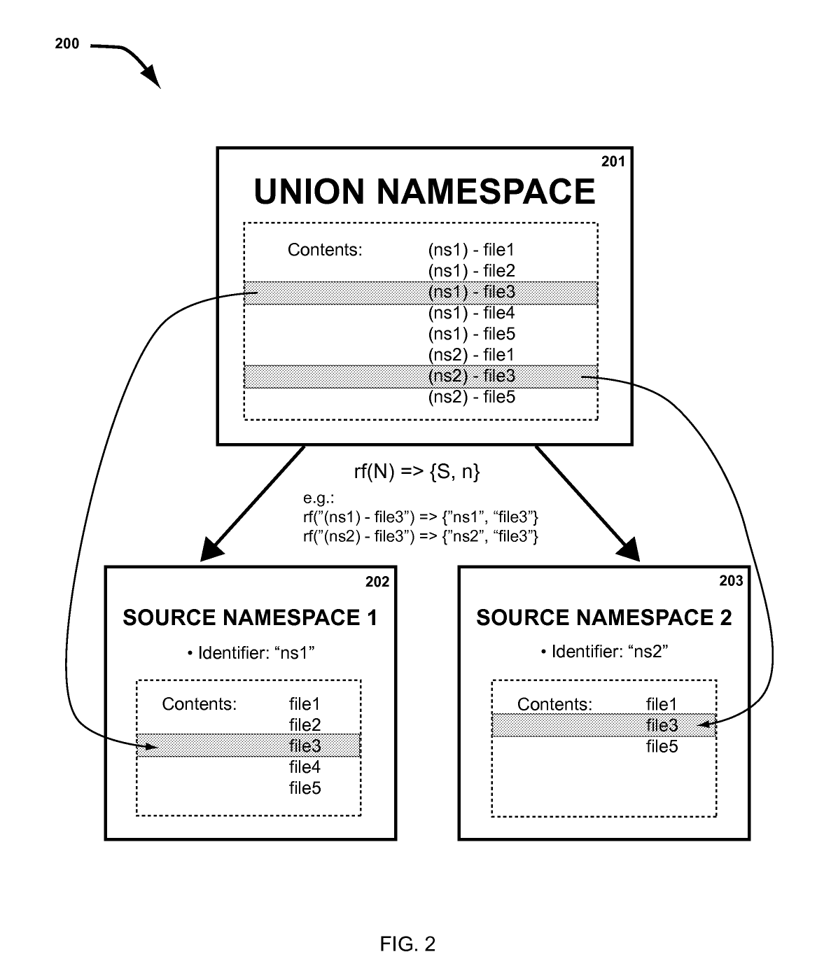

FIG. 2 shows the reverse transformation rf of union names into source names within two source namespaces. FIG. 2 demonstrates the mapping of names in the union namespace represented by block 201, to the original names in their source namespaces, represented by blocks 202 and 203.

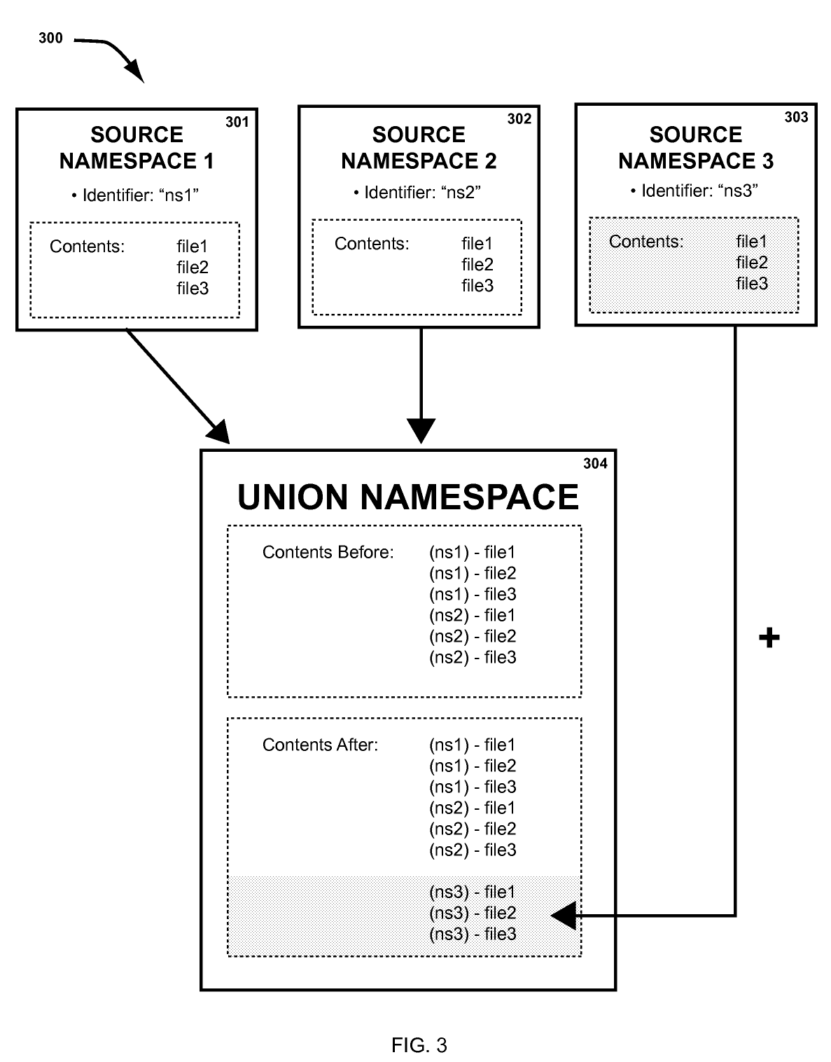

FIG. 3 shows the addition of names from a third source namespace to the existing the union namespace. FIG. 3 begins with an existing union namespace, represented by block 304, populated with names from source namespaces represented by blocks 301 and 302. FIG. 3 shows that there are no naming conflicts introduced in the union namespace when the source namespace represented by block 303 is added to the system.

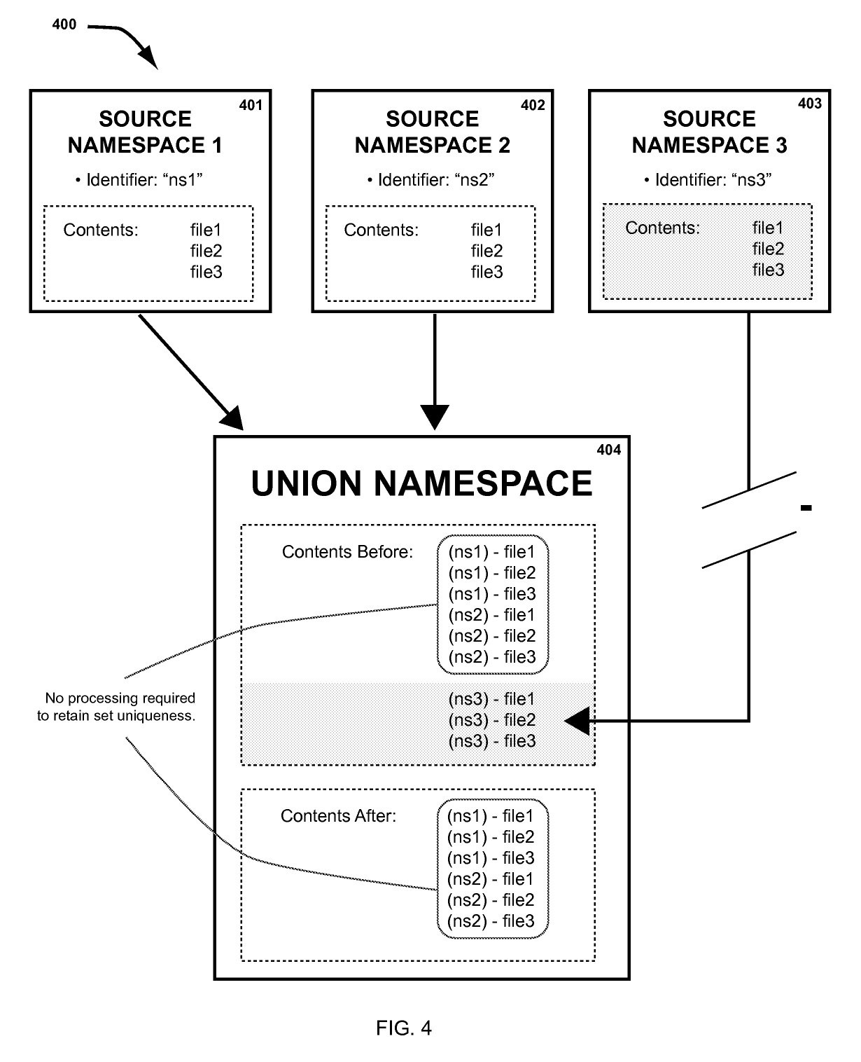

FIG. 4 shows the removal of union names, when all of the names from a source namespace are removed from the union namespace. FIG. 4 begins with an existing union namespace, represented by block 404, populated with names from source namespaces represented by blocks 401, 402, and 403. FIG. 4 shows that, when the source namespace represented by block 403 is removed from the union namespace, no additional processes are required on the names from the remaining source namespaces.

In a preferred embodiment of the invention, the union name is produced and presented to an operating system kernel interface.

In another embodiment, the union name production is at the request of a system kernel interface.

1. A computer implemented method of producing a union name from a source name comprising:
(a) a source name;
(b) a source namespace;
(c) an identifier, wherein the identifier has information to uniquely identify the source namespace of the source name;
wherein, the source name is retrieved from the source namespace and the retrieved source name and the identifier for the source namespace of the retrieved source name are used to generate a unique union name at the time of retrieval.

2. The method of claim 1, wherein the union name is presented in a union namespace.

3. The method of claim 1, wherein any number of source names are retrieved from their source namespaces and each retrieved source name and each identifier for the source namespace of the retrieved source name are used to generate each unique union name at the time of retrieval.

4. The method of claim 3, wherein the union names are presented in a union namespace.

5. A computer-implemented method of producing a source name, and identifying a source namespace where that source name is located, from a union name comprising:
(a) a union name;
wherein the union name is provided, and the union name is transformed into a source name and an identifier with information that uniquely identifies a source namespace where the source name is located.

6. The method of claim 5, wherein the identifier that has information that uniquely identifies the source namespace is used to identify the source namespace where the source name is located, and the source name and the source namespace are presented in at least a human or computer readable format.

7. The method of claim 5, wherein any number of union names are provided, and each union name is transformed into the source name and the identifier with information that uniquely identifies the source namespace where each source name is located.

8. The method of claim 7, wherein the identifier with information that uniquely identifies each source namespace is used to identify each source namespace where each source name is located, and each source name and each source namespace are presented in at least human or computer readable format.

9. A method of allowing namespace operations to be performed across any number of independent file systems comprising:
(a) a set of source namespaces;
(b) a provided set of identifiers, wherein each identifier from the provided set of identifiers is unique and corresponds to one source namespace from the set of source namespaces;
(c) software, wherein the software may access the set of source namespaces and the provided set of identifiers, the software may perform a name transformation on a name in response to a namespace operation request to a unified file system, and the identifier derived from the name is used to complete the unified file system namespace operation.

10. The method of claim 9, wherein one source namespace from the set of source namespaces is selected as an excluded namespace and source names from the excluded from name transformations, wherein the software may use the source names from the excluded namespace to complete namespace operation requests to the unified file system and may identify the location of the source names from the excluded namespace because those source names are not transformed.

11. The method of either claim 1 where the union name produced is presented to an operating system kernel interface.

12. The method of either claim 1 where the union name production is at the request of a system kernel interface.
